(19) United States
(12) Patent Application Publication
(10) Pub. No.: US 2022/0410671 A1
(43) Pub. Date: Dec. 29, 2022

(54) Car Visor Device

(71) Applicant: Emma McKnight, Bronx, NY (US)

(72) Inventor: Emma McKnight, Bronx, NY (US)

(21) Appl. No.: 17/846,453

(22) Filed: Jun. 22, 2022

Related U.S. Application Data
(60) Provisional application No. 63/213,964, filed on Jun. 23, 2021.

(51) Int. Cl. B60J 3/02

(52) U.S. Cl. CPC B60J 3/0208

(57) ABSTRACT

The present invention relates to a novel vehicle visor device. The device is designed to prevent sun glare and excessive sunlight from causing a distraction while driving. The device comprises a standard vehicle visor with an extended visor component. The extended visor component is made of tinted glass and comprises several tinted visor extensions and several tabs on the base of the component. The tabs allow a user to pull down a specific tint and height of the visor extension. Users can easily pull down the tinted visor extensions to prevent excessive sun glare and exposure while driving.

### CROSS-REFERENCE TO RELATED APPLICATION

The present application claims priority to, and the benefit of, U.S. Provisional Application No. 63/213,964, which was filed on Jun. 23, 2021, and is incorporated herein by reference in its entirety.

### FIELD OF THE INVENTION

The present invention relates generally to the field of vehicle visor devices. More specifically, the present invention relates to an improved vehicle visor device that provides users with a new visor attachment for vehicle sun visors that allows shorter users to adjust the height of the visor. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in vehicle visors. Standard vehicle visors can be helpful in blocking excess sunlight and glare when driving; however, some drivers may be too short to fully take advantage of the visor's function. Furthermore, adjusting a vehicle seat to meet the visor's original height may not be possible for users who are shorter than average. Additionally, driving on busy roadways with excess sunlight and/or sun glare can be incredibly dangerous.

As stated supra, although vehicle visors are generally effective for blocking the sun's rays from a driver's eyes, they do not serve the intended purpose when the sun is very low, e.g., immediately after the sun rises and immediately prior to the sun setting. Further, standard visors also cannot protect a driver against an oncoming vehicle's headlights during night driving. Both of the above scenarios constitute dangerous situations for drivers, particularly those that are shorter than normal, and it is thus an object of this invention to at least ameliorate the danger associated with these situations. As such, the disclosed vehicle visor relates to an improved vehicle visor, or to an accessory for a vehicle visor, which acts to ameliorate the above-described dangerous situations.

Thus, it is necessary for users that are shorter than average and/or drivers needing to block the sun's rays from a driver's eyes to have a more effective means for blocking the sun's rays, while not blocking road visibility. Generally, vehicle visors are standard in most motor vehicles, and are also manufactured of a standard length and height. However, many users need a vehicle visor with adjustable heights and varying tints. Therefore, users require a vehicle visor device that prevents sun glare and excessive sunlight from causing a distraction while driving.

Therefore, there exists a long-felt need in the art for a vehicle visor device that provides users with a new visor attachment for vehicle sun visors that allows shorter users to adjust the height of the visor. There is also a long-felt need in the art for a vehicle visor device that features multiple tabs on the base of the visor for users to select different heights and tints of the various extensions. Further, there is a long-felt need in the art for a vehicle visor device that allows users to utilize different tinted glass effects for the visor extensions to adjust the user's vision while driving. Moreover, there is a long-felt need in the art for a device that prevents sun glare and excessive sunlight from causing a distraction while driving. Further, there is a long-felt need in the art for a vehicle visor device that improves overall roadway safety and helps shorter users maintain proper visibility by reducing the amount of sun glare and exposure through the windshield. Finally, there is a long-felt need in the art for a vehicle visor device that is effective at blocking the sun's rays from a driver's eyes, and for protecting a driver against an oncoming vehicles' headlights during night driving.

The subject matter disclosed and claimed herein, in one embodiment thereof, comprises a vehicle visor device. The device is designed to prevent sun glare and excessive sunlight from causing a distraction while driving. The device comprises a standard vehicle visor with an extended visor component. The extended visor component is made of tinted glass and comprises several tinted visor extensions and several tabs on the base of the component. The tabs allow a user to pull down a specific tint and height of the visor extension. Users can easily pull down the tinted visor extensions to prevent excessive sun glare and exposure while driving. Further, the tinted visor extensions can be used to block sun from the windshield and side windows when adjusted to a specific height and location.

In this manner, the vehicle visor device of the present invention accomplishes all of the foregoing objectives and provides users with a device that improves overall roadway safety and helps shorter users maintain proper visibility while driving. The device allows a user to utilize different tinted visor extensions to adjust the user's vision while driving. The device reduces the amount of sun glare and exposure through the windshield for all users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle visor device. The device is designed to prevent sun glare and excessive sunlight from causing a distraction while driving. The device comprises a standard vehicle visor with an extended visor component. The extended visor component is made of tinted glass and comprises several tinted visor extensions and several tabs on the base of the component. The tabs allow a user to pull down a specific tint and height of the visor extension. Users can easily pull down the tinted visor extensions to prevent excessive sun glare and exposure while driving. Further, the tinted visor extensions can be used to block sun from the windshield and side windows when adjusted to a specific height and location.

It is known that most motor vehicles are provided with at least one visor that is displaceable between an inoperative configuration, in which it is “folded” away, and an operative configuration, in which it serves as a sun shield for a vehicle driver. Insofar as the general configuration of these vehicle visors is well known, it is not described in further detail herein.

As stated supra, the visor of the present invention is configured to be the same shape and size of a standard motor vehicle visor and comprises top and bottom opposing sides, as well as right and left opposing sides and a hinge component that allows the visor to be folded up toward a vehicle ceiling and extended down toward the vehicle windshield. In one embodiment, the visor of the device is a standard vehicle visor as is known in the art and the extended visor component is an add-on. The extended visor component can be mounted to the visor via any suitable securing means as is known in the art, such as glue, screws, Velcro, snaps, etc., depending on the needs and/or wants of a user. In another embodiment, the visor and the extended visor component are manufactured together as one integral piece and replace the standard vehicle visor within the motor vehicle.

In one embodiment, the extended visor component comprises a plurality of tinted visor extensions, which are tinted, transparent sheet elements. The tinted visor extensions are typically rectangular in shape and are sized to be retained by the visor and not seen, however the tinted visor extensions can be any suitable shape and size as is known in the art, depending on the needs and/or wants of a user. The tinted visor extensions comprise components of varying tint and height. Any number of tinted visor extensions can be utilized with the device, depending on the needs and/or wants of a user. The tinted visor extensions can be tinted any suitable shade as is known in the art. Typically, the tinted visor extensions would each be tinted a different shade and each shade tint would gradually get darker, but any suitable shade can be utilized as is known in the art. Further, the tinted visor extensions would each be sized to be a different height when extended down toward the windshield, with each tinted visor extension providing more coverage for the user.

In another embodiment, the extended visor component is mounted on a vehicle visor in a configuration in which, for use of the accessory, the plurality of tinted visor extensions are displaceable from a first position, in which the visor extensions are located generally within the perimeter of the vehicle visor, to a second position, in which the visor extensions extend from the bottom edge of the vehicle visor (i.e., remote from the edge that coincides substantially with the axis about which the vehicle visor is pivotally displaceable). The inherent flexibility of the material forming the plurality of tinted visor extensions allows for movement between the first position and the second position.

More particularly, the means for mounting the plurality of tinted visor extensions may include an elongated strip-like element that is securable to a vehicle visor on either side in a configuration in which it extends across the width of the visor, and an elongate rod carried by the strip-like element in a configuration in which it extends along the length. The plurality of tinted visor extensions are positioned on the rod in a configuration in which the extensions are pivotally displaceable between the first position and the second position and in which they are slidable along the length of the rod. Further, to secure the strip-like element to a vehicle visor, the mounting means may include double-sided adhesive tape that permits the attachment of the strip-like element to a vehicle visor. Clearly, alternative securing means also may be provided for this purpose.

Further, the vehicle visor in an operative configuration with at least one tinted visor extension extended, is positioned to serve as a shield for the eyes of a vehicle driver against the rays of a light source, while retaining road visibility through and around the extended tinted visor extension. When referring to the rays of a light source, reference is particularly made to the rays of a setting/rising sun and the rays of the headlights of oncoming vehicles. With the visor positioned as defined and with at least one tinted visor extension extended in place, the driver of an associated vehicle can look through and around the tinted visor extension when viewing the road ahead of their vehicle during driving. Thus, the tinted visor extension is positioned to effectively shield the driver's eyes from the direct rays of the sun, particularly when very low, or from the rays of the headlights of an oncoming vehicle.

In one embodiment, the tinted visor extensions may be formed of a polymer material or other plastic, or a polycarbonate material, etc., or any other suitable transparent synthetic plastic material as is known in the art. Further, the tinting of the material can be done at any suitable shade as is known in the art, such that it is effective in shielding the eyes of a vehicle driver against the rays of the sun, or another vehicle's headlights, while still permitting at least limited road vision.

In another embodiment, the overall dimensions and the shape of the tinted visor extensions may be greatly variable and, in particular, may be determined based on the needs and/or wants of a user. Generally, in this regard, the width of the tinted visor extensions may be approximately between one quarter and one third of the width of a vehicle visor of the type commonly provided in a motor vehicle. Also, when extended toward the windshield, the tinted visor extensions may be approximately dimensioned to extend between 30 mm and 50 mm from the edge of the vehicle visor.

In one embodiment, the plurality of tinted visor extensions comprise a tab located at the bottom edge of each of the tinted visor extensions. The tabs allow a user to grasp the desired visor extension and easily pull/extend the tinted visor extension in place in front of a user's eyes. Any suitable grasping component can be utilized as is known in the art, depending on the needs and/or wants of a user.

In yet another embodiment, the vehicle visor device comprises a plurality of indicia.

In yet another embodiment, a method of preventing sun glare and excessive sunlight from causing a distraction while driving is described. The method includes the steps of providing a vehicle visor device comprising a visor with an extended visor component. The method also comprises positioning the visor in a user's vehicle. Further, the method comprises pulling down a predetermined tinted visor extension from the extended visor component. Finally, utilizing the extended visor component to block sun and/or headlights from the windshield while driving.

In use, when driving into, for example, a setting sun, the visor will be displaced into its operative configuration and the desired tinted visor extension is extended down toward the windshield, and further adjusted so that the tinted visor extension will serve as an effective shield for the driver's eyes against the direct rays of the setting sun. Further, being transparent but tinted, at least limited road visibility through the tinted visor extension is permitted to enable normal driving. The limited visibility permits the driver to set the tinted visor extension in a position in which the sun is centrally located with respect to the extension, thus not requiring continuous adjustment when the vehicle deviates from its path of travel. Further, the degree of tinting must be such that when driving into a setting sun, the driver should be able to continue driving without being unduly affected by the sun. Additionally, when driving into a low setting/rising sun, or towards the lights of an oncoming vehicle, the motor vehicle visor cannot serve as a shield for a driver's eyes, as it will then also block road vision. Accordingly, the tinted visor extensions of the present invention act to correct this issue by shielding the driver's eyes against the direct rays/lights, while also allowing road visibility.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate perspective views of one embodiment of the vehicle visor device of the present invention in accordance with the disclosed architecture;

FIG. 2 illustrates a perspective view of one embodiment of the vehicle visor device of the present invention installed within the vehicle in accordance with the disclosed architecture;

FIG. 3 illustrates a perspective view of one embodiment of the vehicle visor device of the present invention wherein one of the tabs is pulled to reveal the selected visor extension in accordance with the disclosed architecture;

FIG. 4 illustrates a perspective view of one embodiment of the vehicle visor device of the present invention in use during dusk or dawn hours in accordance with the disclosed architecture;

FIG. 5 illustrates a perspective view of one embodiment of the vehicle visor device of the present invention in use at nighttime in accordance with the disclosed architecture; and

FIG. 6 illustrates a flowchart showing the method of preventing sun glare and excessive sunlight from causing a distraction while driving in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a vehicle visor device that provides users with a new visor attachment for vehicle sun visors that allows shorter users to adjust the height of the visor. There is also a long-felt need in the art for a vehicle visor device that features multiple tabs on the base of the visor for users to select different heights and tints. Further, there is a long-felt need in the art for a vehicle visor device that allows users to utilize different tinted glass effects for the visor extensions to adjust the user's vision while driving. Moreover, there is a long-felt need in the art for a device that prevents sun glare and excessive sunlight from causing a distraction while driving. Further, there is a long-felt need in the art for a vehicle visor device that improves overall roadway safety and helps shorter users maintain proper visibility by reducing the amount of sun glare and exposure through the windshield. Finally, there is a long-felt need in the art for a vehicle visor device that is effective at blocking the sun's rays from a driver's eyes, and for protecting a driver against an oncoming vehicles' headlights during night driving.

The present invention, in one exemplary embodiment, is a novel vehicle visor device. The device is designed to prevent sun glare and excessive sunlight from causing a distraction while driving. The device comprises a standard vehicle visor with an extended visor component. The extended visor component is comprised of a tinted glass or plastic and comprises several tinted visor extensions and several tabs on the base of the component. The tabs allow a user to pull down a specific tint and height of the visor extension. Users can easily pull down the tinted visor extensions to prevent excessive sun glare and exposure while driving. The present invention also includes a novel method of preventing sun glare and excessive sunlight from causing a distraction while driving. The method includes the steps of providing a vehicle visor device comprising a visor with an extended visor component. The method also comprises positioning the visor in a user's vehicle. Further, the method comprises pulling down a predetermined tinted visor extension from the extended visor component. Finally, utilizing the extended visor component to block sun and/or headlights from the windshield while driving.

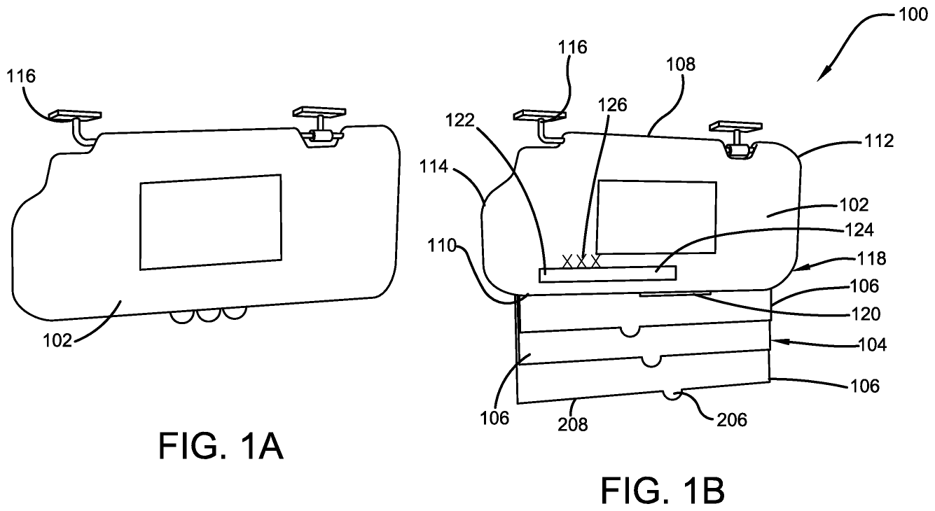

Referring initially to the drawings, FIGS. 1A-B illustrate perspective views of one embodiment of the vehicle visor device 100 of the present invention. In the present embodiment, the vehicle visor device 100 is an improved vehicle visor device that prevents sun glare and excessive sunlight from causing a distraction while driving. The device 100 is especially designed to allow any vehicle driver of commercial or personal vehicles, etc., or any other suitable user as is known in the art, to easily maintain proper visibility by reducing the amount of sun glare and exposure through the windshield while driving. More specifically, the device 100 comprises a vehicle visor 102 with an extended visor component 104. The extended visor component 104 comprises a plurality of tinted visor extensions 106. Users can easily pull down the desired tinted visor extension 106 to prevent excessive sun glare and exposure while driving. Further, the tinted visor extension 106 can be used to block sun from the windshield 200 and side windows 202 when adjusted to a specific height and location.

It is known that most motor vehicles are provided with at least one visor 102 that is displaceable between an inoperative configuration, in which it is “folded” away, and an operative configuration, in which it serves as a sun shield for a vehicle driver. Insofar as the general configuration of these vehicle visors is well known, it is not described in further detail herein.

As stated supra, the visor 102 of the present invention is configured to be the same shape and size of a standard motor vehicle visor and comprises top 108 and bottom opposing sides 110, as well as right 112 and left opposing sides 114 and a hinge component 116 that allows the visor 102 to be folded up toward a vehicle ceiling 204 and extended down toward the vehicle windshield 200. In one embodiment, the visor 102 of the device 100 is a standard vehicle visor as is known in the art and the extended visor component 104 is an add-on. The extended visor component 104 can be mounted to the visor 102 via any suitable securing means as is known in the art, such as glue, screws, Velcro, snaps, etc., depending on the needs and/or wants of a user. In another embodiment, the visor 102 and the extended visor component 104 are manufactured together as one integral piece and replace the standard vehicle visor within the motor vehicle.

Furthermore, the extended visor component 104 comprises a plurality of tinted visor extensions 106, which are tinted, transparent sheet elements. The tinted visor extensions 106 are typically rectangular in shape and are sized to be retained by the visor 102 and not seen, however the tinted visor extensions 106 can be any suitable shape and size as is known in the art, depending on the needs and/or wants of a user. Specifically, the tinted visor extensions 106 comprise components of varying tint and height, allowing a user to customize the amount of tint and coverage they want. Any suitable number of tinted visor extensions 106 can be utilized with the device 100, depending on the needs and/or wants of a user. However, typically there are three tinted visor extensions 106 included with the device 100. Further, the tinted visor extensions 106 can be tinted any suitable shade as is known in the art. Typically, the tinted visor extensions 106 would each be tinted a different shade and each shade tint would gradually get darker, but any suitable shade can be utilized as is known in the art. Further, the tinted visor extensions 106 would each be sized to be a different height when extended down toward the windshield 200, with each tinted visor extension 106 providing more coverage for the user.

In one embodiment, the extended visor component 104 is mounted on a vehicle visor 102 in a configuration in which the plurality of tinted visor extensions 106 are displaceable from a first position (shown in FIG. 1A), in which the visor extensions 106 are located generally within the perimeter 118 of the vehicle visor 102, to a second position (shown in FIG. 1B), in which the visor extensions 106 extend from the bottom edge 120 of the vehicle visor 102 (i.e., remote from the edge that coincides substantially with the axis about which the vehicle visor 102 is pivotally displaceable). Further, the inherent flexibility of the material forming the plurality of tinted visor extensions 106 allows for movement between the first position and the second position.

More particularly, the means for mounting the plurality of tinted visor extensions 106 may include an elongated strip-like element 122 that is securable to a vehicle visor 102 on either side in a configuration in which it extends across the width of the visor 102, and an elongate rod 124 carried by the strip-like element 122 in a configuration in which it extends along the length. The plurality of tinted visor extensions 106 are positioned on the rod 124 in a configuration in which the extensions 106 are pivotally displaceable between the first position and the second position and in which they are slidable along the length of the rod 124. Further, to secure the strip-like element 122 to a vehicle visor 102, the mounting means may include double-sided adhesive tape 126 that permits the attachment of the strip-like element 122 to a vehicle visor 102. Clearly, alternative securing means also may be provided for this purpose.

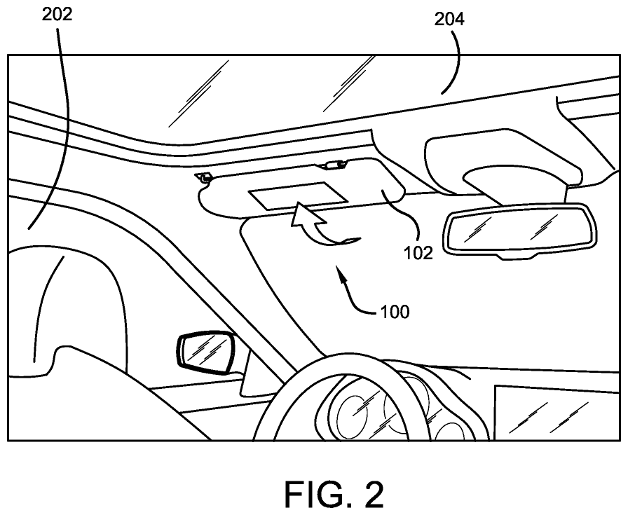

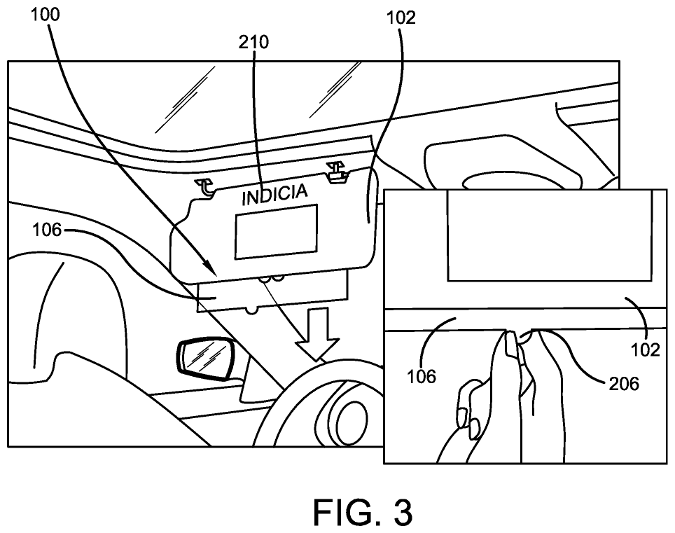

As shown in FIGS. 2-3, the vehicle visor 102, in an operative configuration with at least one tinted visor extension 106 extended, is positioned to serve as a shield for the eyes of a vehicle driver against the rays of a light source, while retaining road visibility through and around the extended tinted visor extension 106. When referring to the rays of a light source, reference is particularly made to the rays of a setting/rising sun and the rays of the headlights of oncoming vehicles. With the visor 102 positioned as defined and with at least one tinted visor extension 106 extended in place (as shown in FIG. 3), the driver of an associated vehicle can look through and around the tinted visor extension 106 when viewing the road ahead of their vehicle during driving. Thus, the tinted visor extension 106 is positioned to effectively shield the driver's eyes from the direct rays of the sun, particularly when very low, or from the rays of the headlights of an oncoming vehicle.

In one embodiment, the tinted visor extensions 106 may be formed of plastic or polymers, such as polypropylene or acrylonitrile-butadiene-styrene (ABS), or any other suitable material as is known in the art, such as, but not limited to, acrylic, polycarbonate, polyethylene, thermoplastic, polyethylene terephthalate, polyvinyl chloride, polystyrene, etc., or any other suitable transparent synthetic plastic material as is known in the art. Further, the tinting of the material can be done at any suitable shade as is known in the art, such that it is effective in shielding the eyes of a vehicle driver against the rays of the sun, or another vehicle's headlights, while still permitting at least limited road vision.

Further, the overall dimensions and the shape of the tinted visor extensions 106 may be greatly variable and, in particular, may be determined based on the needs and/or wants of a user. Generally in this regard, the width of the tinted visor extensions 106 may be approximately between one quarter and one third of the width of a vehicle visor 102 of the type commonly provided in a motor vehicle. Also, when extended toward the windshield 200, the tinted visor extensions 106 may be approximately dimensioned to extend between 30 mm and 50 mm from the edge 120 of the vehicle visor 102.

In one embodiment, the plurality of tinted visor extensions 106 comprise a tab 206 located at the bottom edge 208 of each of the tinted visor extensions 106. Typically, the tabs 206 are an integral component of the tinted visor extensions 106, but do not have to be and can be separate components adhered to the tinted visor extensions 106. The tabs 206 can be adhered to the tinted visor extensions 106 via any suitable adhering means as is known in the art, such as gluing, adhesives, etc. The tabs 206 allow a user to grasp the desired visor extension 106 and easily pull/extend the tinted visor extension 106 in front of a user's eyes. Any suitable grasping component can be utilized as is known in the art, depending on the needs and/or wants of a user.

In yet another embodiment, the vehicle visor device 100 comprises a plurality of indicia 210. The visor 102 of the device 100 may include advertising, a trademark, or other letters, designs, or characters, printed, painted, stamped, or integrated into the visor 102, or any other indicia 210 as is known in the art. Specifically, any suitable indicia 210 as is known in the art can be included, such as, but not limited to, patterns, logos, emblems, images, symbols, designs, letters, words, characters, animals, advertisements, brands, etc., that may or may not be vehicle or brand related.

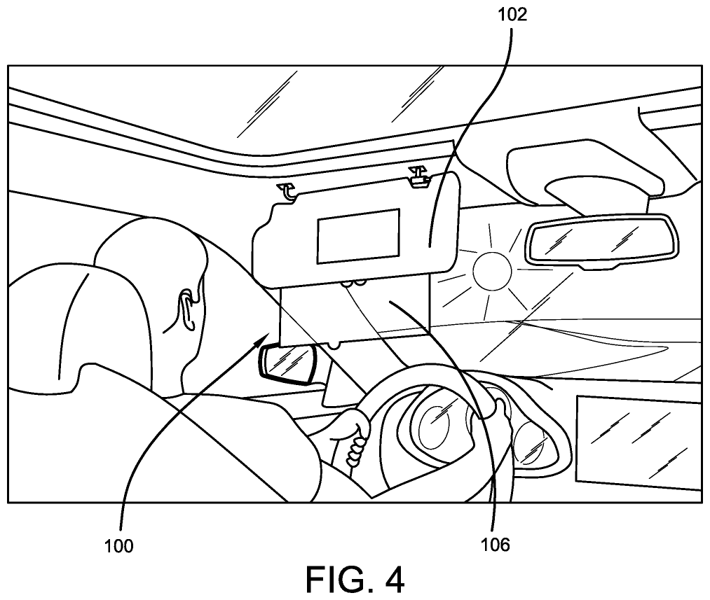

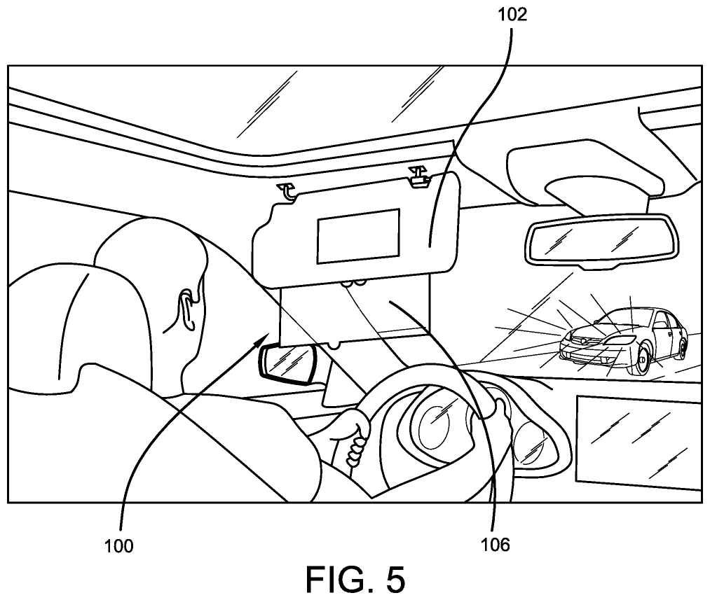

As shown in FIGS. 4-5, in use, when driving into, for example, a setting sun, the visor 102 will be displaced into its operative configuration and the desired tinted visor extension 106 is extended down toward the windshield 200, and further adjusted so that the tinted visor extension 106 will serve as an effective shield for the driver's eyes against the direct rays of the setting sun. Further, being transparent but tinted, at least limited road visibility through the tinted visor extension 106 is permitted to enable normal driving. The limited visibility permits the driver to set the tinted visor extension 106 in a position in which the sun is centrally located with respect to the extension 106, thus not requiring continuous adjustment when the vehicle deviates from its path of travel. Further, the degree of tinting must be such that when driving into a setting sun, the driver should be able to continue driving without being unduly affected by the sun. Additionally, when driving into a low setting/rising sun, or towards the lights of an oncoming vehicle, the motor vehicle visor 102 cannot serve as a shield for a driver's eyes, as it will then also block road vision. Accordingly, the tinted visor extensions 106 of the present invention act to correct this issue by shielding the driver's eyes against the direct rays/lights, while also allowing road visibility.

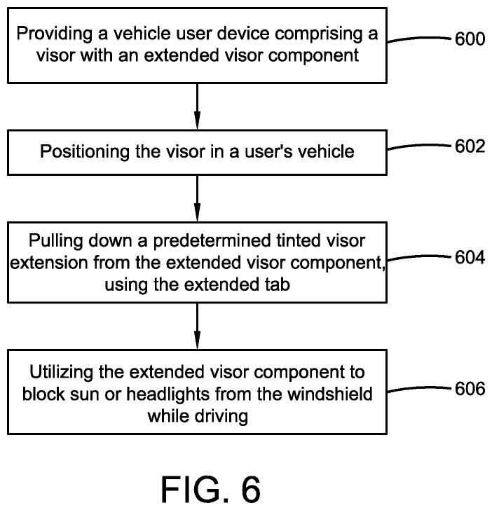

FIG. 6 illustrates a flowchart of the method of preventing sun glare and excessive sunlight from causing a distraction while driving. The method includes the steps of at 600, providing a vehicle visor device comprising a visor with an extended visor component, wherein the extended visor component comprises a plurality of tinted visor extensions. The method also comprises at 602, positioning the visor in a user's vehicle. Further, the method comprises at 604, pulling down a predetermined tinted visor extension from the extended visor component, using the attached tab. Specifically, the plurality of visor extensions are tinted, transparent sheet elements. The tinted visor extensions are typically rectangular in shape and are sized to be retained by the visor and not seen. Furthermore, the tinted visor extensions comprise components of varying tint and height, allowing a user to customize the amount of tint and coverage they want. Finally, at 606, utilizing the extended visor component to block sun and/or headlights from the windshield while driving.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “vehicle visor device” and “device” are interchangeable and refer to the vehicle visor device 100 of the present invention.

Notwithstanding the foregoing, the vehicle visor device 100 of the present invention can be of any suitable size and configuration as is known in the art without affecting the overall concept of the invention, provided that it accomplishes the above-stated objectives. One of ordinary skill in the art will appreciate that the vehicle visor device 100 as shown in FIGS. 1-6 are for illustrative purposes only, and that many other sizes and shapes of the vehicle visor device 100 are well within the scope of the present disclosure. Although the dimensions of the vehicle visor device 100 are important design parameters for user convenience, the vehicle visor device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle visor device for preventing sun glare and excessive sunlight from causing a distraction while driving, the vehicle visor device comprising:
a vehicle visor; and
an extended visor component comprising a plurality of tinted visor extensions, wherein the vehicle visor and the extended visor component are secured within a motor vehicle, and further wherein each of the plurality of tinted visor extensions are repositionable.

2. The vehicle visor device of claim 1, wherein the plurality of tinted visor extensions are sized and configured to block sun glare and excessive sunlight from a windshield or side windows when adjusted to a specific height and location.

3. The vehicle visor device of claim 2, wherein the vehicle visor comprises a top and a bottom opposing sides and a right and a left opposing sides.

4. The vehicle visor device of claim 3, wherein the vehicle visor comprises a hinge component that allows the vehicle visor to be folded up toward a vehicle ceiling and extended down toward a vehicle windshield.

5. The vehicle visor device of claim 4, wherein the vehicle visor and the extended visor component are an integral component.

6. The vehicle visor device of claim 4, wherein the extended visor component is mounted onto the vehicle visor.

7. The vehicle visor device of claim 1, wherein each of the plurality of tinted visor extensions is rectangular in shape and sized to be retained by the vehicle visor and are not visible when not in use.

8. The vehicle visor device of claim 7, wherein the plurality of tinted visor extensions comprise varying degrees of tint and height, thereby allowing a user to customize an amount of tint and coverage desired.

9. The vehicle visor device of claim 8, wherein the plurality of tinted visor extensions comprise three tinted visor extensions.

10. The vehicle visor device of claim 9, wherein the plurality of tinted visor extensions are displaceable from a first position, in which the plurality of tinted visor extensions are located generally within a perimeter of the vehicle visor, to a second position, in which the plurality of tinted visor extensions extend from a bottom edge of the vehicle visor.

11. The vehicle visor device of claim 10, wherein a means for mounting the plurality of tinted visor extensions comprises an elongate strip-like element that is securable to the vehicle visor in a configuration that extends across a width of the vehicle visor.

12. The vehicle visor device of claim 11, wherein the means for mounting further comprises an elongate rod carried by the strip-like element in a configuration that extends along a length of the vehicle visor.

13. The vehicle visor device of claim 12, wherein the plurality of tinted visor extensions are positioned on the elongate rod in a configuration in which the plurality of tinted visor extensions are pivotally displaceable between the first position and the second position and are slidable along a length of the elongate rod.

14. The vehicle visor device of claim 13, wherein the strip-like element is secured to the vehicle visor via a double-sided adhesive tape.

15. A vehicle visor device for preventing sun glare and excessive sunlight from causing a distraction while driving, the vehicle visor device comprising:
a vehicle visor comprising a top and a bottom opposing sides, a right and a left opposing sides, and a hinge component that allows the vehicle visor to be folded up toward a vehicle ceiling and extended down toward a vehicle windshield; and
an extended visor component; and
wherein the extended visor component comprises a plurality of tinted visor extensions which are rectangular in shape and sized to be retained by the vehicle visor and not seen;
wherein the plurality of tinted visor extensions comprise varying degrees of tint and height, allowing a user to customize amount of tint and coverage they want;
wherein the vehicle visor and the extended visor component are secured within a motor vehicle; and
wherein the plurality of tinted visor extensions are displaceable from a first position, in which the plurality of tinted visor extensions are located generally within a perimeter of the vehicle visor, to a second position, in which the plurality of tinted visor extensions extend from a bottom edge of the vehicle visor to serve as a shield for a user's eyes while driving.

16. The vehicle visor device of claim 15, wherein the plurality of tinted visor extensions each comprise a tab located at the bottom edge.

17. The vehicle visor device of claim 15, wherein the vehicle visor device comprises a plurality of indicia.

18. The vehicle visor device of claim 15, wherein the plurality of tinted visor extensions comprise three tinted visor extensions.

19. The vehicle visor device of claim 15, wherein the extended visor component is mounted onto the vehicle visor.

20. A method of preventing sun glare and excessive sunlight from causing a distraction while driving, the method comprising the steps of:
providing a vehicle visor device comprising a visor with an extended visor component, wherein the extended visor component comprises a plurality of tinted visor extensions;
positioning the visor in a user's vehicle;
pulling down a predetermined tinted visor extension from the extended visor component, using the attached tab; and
utilizing the extended visor component to block sun or headlights from the windshield while driving.
